(19) United States
(12) Patent Application Publication
(10) Pub. No.: US 2006/0226193 A1
(43) Pub. Date: Oct. 12, 2006

(54) Gas-operated apparatuses with precompression chamber and propulsion chamber

(75) Inventor: Bruno Toulouse, Valence (FR)

Correspondence Address: LOWE, HAUPTMAN, GILMAN & BERNER, LLP (ITW), 1700 DIAGONAL ROAD, SUITE 300, ALEXANDRIA, VA, 22314, US

(73) Assignee: SOCIETE DE PROSPECTION ET D'INVENTIONS TECHNIQUES SPIT, Bourg les Valence (FR)

(21) Appl. No.: 10/549,123

(22) PCT Filed: Mar. 19, 2004
(86) PCT No.: PCT/IB04/01314

§ 371 Date: Jun. 23, 2006

(30) Foreign Application Priority Data
Mar. 19, 2003 (FR) 03/03370

(51) Int. Cl. B25C 1/14

(52) U.S. Cl. 227/10

(57) ABSTRACT

The apparatus comprises: a first chamber for the precompression of a combustible gas and generation of a flame, a second propulsion chamber, and placing elements, the two chambers in communication, these elements being designed to allow the flame to pass. There is an intermediate third chamber for the compression and acceleration of the flame, connecting the first and second chambers. The invention is neatly applicable to sealing apparatuses with a propulsion piston.

The invention relates to a gas-operated apparatus comprising a first chamber of a first volume comprising means for igniting a combustible gas and generating a flame, a second chamber of a second volume, and means for placing the two chambers in communication, these means being designed to allow the flame to pass.

The invention relates more particularly to an internal combustion gas-operated sealing apparatus in which a piston is propelled under the action of the exploding of a mixture of gas and air in order, via its rod, to strike a nail; this is then a gas-operated nail gun, or some other fastening device.

Apparatuses with two chambers have advantages. With two chambers, the first is a precompression chamber which allows the explosion pressure in the second chamber to be increased, the explosion pressure in a volume being proportional to the pressure of the mixture before the explosion. What happens is that, because of the explosion in the first chamber, the combustion pressure thus generated in this first chamber compresses the unburnt mixture which is pushed by the flame front and passes into the second chamber to increase the pressure therein before the explosion occurs in this second chamber. If this second chamber is partially delimited by a drive piston, then by virtue of this precompression, the piston has moved only very slightly forwards at the time when the explosion occurs in this second chamber for propelling the piston, this allowing the piston to derive correct benefit from the energy of combustion of the gas.

When, in addition, there is a fan in the flame-generating chamber, the rate of combustion and the maximum pressure level in this chamber are increased, making it possible to reduce the rise time of this pressure and therefore to further limit the movement of the piston in its drive chamber before the explosion takes place, and therefore making it possible to further increase the power of the apparatus.

It will be noted that the effect of an accelerating fan is more than significant; it allows the pressure rise time to be reduced by a factor of the order of 10.

However, and even with a precompression chamber or combustion prechamber, the applicant company has realized that the full benefit of the energy of combustion of the gas cannot be enjoyed and that, as a result, there was a need to seek to further improve the pressure level and rate of combustion in the second, drive, chamber, and thus to increase the power of two-chamber apparatuses.

What happens is that the flame generated in the first, precompression, chamber passes into the second, drive, chamber before all of the unburnt mixture from the first chamber has been able to enter the second chamber to increase the pressure therein. Now, as soon as the flame passes across into the second chamber, the explosion occurs.

In addition, given the relationship

$$\frac{pV}{T} = constant$$

the more one wishes to increase the pressure in the drive chamber, the more the volume of the first, precombustion, chamber needs to be increased, and this is not necessarily desirable.

It is therefore under these circumstances that the applicant is proposing its invention.

Thus, the invention relates first of all to a gas-operated apparatus comprising
a first chamber for the precompression of a combustible gas and generation of a flame,
a second, propulsion, chamber, and
means for placing the two chambers in communication, these means being designed to allow the flame to pass,
   characterized in that there is
an intermediate third chamber for the compression and acceleration of the flame, connecting the first and second chambers.

By virtue of the invention it can be certain that at least all the volume of mixture from the intermediate third chamber is driven into the second, propulsion, chamber to increase the pressure therein, the flame generated in the first chamber passing through the inlet and the outlet of the intermediate chamber.

As a preference, the intermediate third chamber for the compression and acceleration of the flame is a tubular chamber, preferably with a cross section roughly equal to that of the flame generated in the first, flame-generating, chamber.

Advantageously, an accelerating fan is provided in the first, flame-generating, chamber.

In general, the apparatus of the invention will be a sealing apparatus, the second, propulsion, chamber being delimited in particular by a piston for driving a fastener and intended to be propelled under the action of the exploding of the mixture in this second, propulsion, chamber.

By way of comparison and to provide a good illustration, it will be emphasized that, in a conventional apparatus with just one chamber for the generation of the flame and propulsion of the piston, the piston may have been moved, at the pressure spike, by about 2 cm, for an overall travel of about 10 cm; in a two-chamber apparatus, this lost travel portion may be reduced by half, to about 1 cm, and, in the apparatus of the invention, reduced further by a factor of 3 or 4, to about 0.3 cm.

By virtue of the invention, as the useful volume essentially lies in the intermediate chamber, the volume of the first, flame-generating, chamber can be reduced and this then has the additional advantage of greatly facilitating the conditions under which the burnt mixture can escape and under which the apparatus can be cooled.

It may even be desirable to establish conditions at the limits of convergence of the first chamber and of the intermediate chamber, and so the applicant company also intends to claim a gas-operated apparatus comprising
a first chamber for the precompression of a combustible gas and generation of a flame,
a second, propulsion, chamber, and
means for placing the two chambers in communication, these means being designed to allow the flame to pass,
   characterized in that:
the first chamber is designed to be a chamber for precompression, generation of a flame and for the compression and acceleration of the flame.

In one case, with two chambers, or in the other, with just one chamber upstream of the propulsion chamber, it is preferable to provide valve means at the entry to this propulsion chamber.

Advantageously, in the case of a sealing apparatus with a piston for driving the fasteners, comprising a body in which the piston is slidably mounted, a housing for accommodating a fasteners loader and a handling and operating handle, the chamber or chambers for the generating of a flame, the compression and acceleration of the flame, are formed in the handle, making modular design of the apparatus easier and reducing its size.

The invention will be better understood with the aid of the following description of various embodiments of the apparatus of the invention, with reference to the attached drawing in which:

FIG. 1 is a schematic depiction of the three-chamber apparatus;

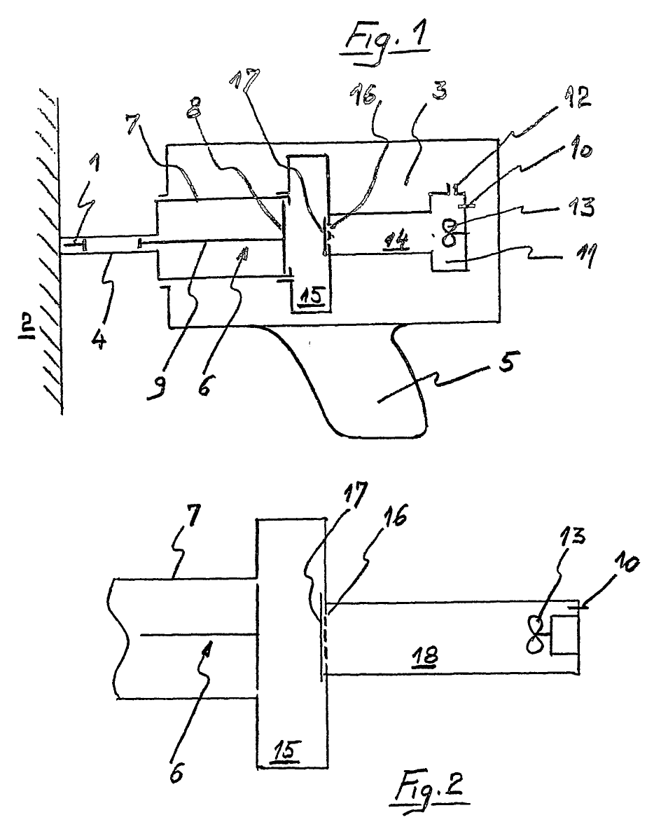

FIG. 2 is a schematic depiction of the two-chamber apparatus and

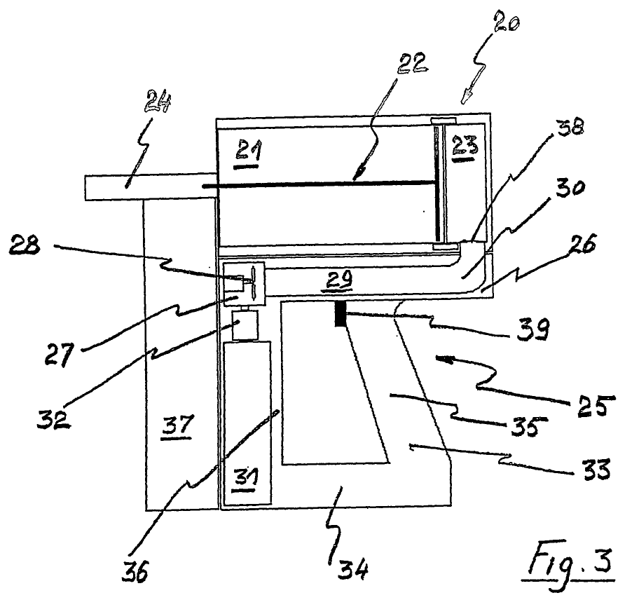

FIG. 3 is a schematic depiction of a modular alternative form of the apparatus of FIG. 1.

The apparatus of FIG. 1 is a gas-operated nail gun for driving nails 1 into a material 2. It comprises a body 3 with, at the front, a tip guide 4 and, at the bottom, a handling and operating handle 5. To drive the nails 1, a piston 6, via its head 8, is mounted to slide in a cylinder 7. The piston 6 has a rod 9 for pushing the nails 1. The body 3 comprises a housing for accommodating a cartridge of a combustible gas intended to be injected into a set of combustion chambers before the gas and air mixture is ignited to propel the piston 6. The body 3 also comprises a cylinder head bearing an igniter plug 10 for igniting the mixture.

Here, in the body 3, there is a first chamber 11, with a gas inlet orifice 12 into which the igniter plug 10 protrudes, which chamber is a chamber for the precompression of the gas-air mixture and for generating a flame. The fan 13 of a motor-fan unit is mounted in this first chamber 11. The chamber 11 communicates with the entrance to a tubular intermediate chamber 14 which is a chamber for compression and acceleration of the flame. The tubular intermediate chamber 14 communicates, via its outlet and via a number of orifices 16 that can be closed off by a valve 17, with a last chamber 15, delimited in part by the piston head 8, which is a propulsion chamber.

The way in which the apparatus works will now be explained.

After the last, propulsion, chamber 15 has been closed and gas has been injected into the first chamber 11, the plug 10 will create a spark which will ignite the mixture of gas and air in the chamber 11, the burning of which mixture will cause the pressure in this chamber to rise. Because of the increase in pressure, the unburnt mixture from the first chamber 11 and especially from the intermediate tubular chamber 14 will, via the orifices 16, pass into the last, propulsion, chamber 15 and thus compress the mixture therein. The combustion flame, generated in the first chamber 11, on arrival in the tubular chamber 14, will be accelerated (almost exponentially) by virtue of the rise in pressure downstream, in the propulsion chamber 15. Passing through the same orifices 16, the flame will ignite the mixture in the last chamber 15, here then according to a “multipoint” ignition strategy.

The pressure in this last chamber will rise to a level above that of the two upstream chambers 14 and 11, and in a shorter space of time. The orifices 16 for communication between the last two chambers 14, 15 generate sonic flows, that is to say that the speed of the mixture and of the flame becomes higher than the speed of sound, by virtue of which the rate of combustion in the last, propulsion, chamber 15 will be very high. This being the case, there is practically no longer any need to hold the piston 6 still to prevent it from moving right at the start of the pressure rise. The rate of combustion is such that the maximum pressure is reached before the piston 6 has had time to move. In this particular instance, this lost movement is reduced to just a few millimetres.

It will be noted that the “multipoint” communication between chambers, in this instance the chambers 14 and 15, encourages the agitation of the mixture in the propulsion chamber 15 before the flame arrives.

The valve or valves blocking off the communication orifices may be used as pressure limiters and open only at a predetermined pressure so as to encourage sonic flow and increase the rate of combustion in the propulsion chamber 15.

It is also possible to envisage mechanical or electrical precompression in the first chamber, within the limit to which the valves open, in order to further increase the pressure level in the first chamber 11 and thus also in the propulsion chamber 15. The flame-generating 11 and propulsion 15 chambers may have a very small volume, making it possible to use less gas and thus improve the efficiency of the apparatus.

By way of indication, whereas the efficiency of a gas-operated nail gun of the prior art does not exceed 6 to 8%, it is possible, with the apparatus of the invention, to envisage practically twice this efficiency, of the order of 13 to 14%. Likewise, the number of shots per gas cartridge, with apparatus of the prior art, was of the order of 750 and with the apparatus of the invention this can be extended to 1500 or even 2000. As to the number of shots per charge of the battery with which the apparatus is equipped, for operating the motor-fan unit and the igniter plug, this is about 900 in a conventional apparatus and may exceed 2000 or even 3000 in the apparatus of the invention.

The first, flame-generating, chamber may be coincident with the chamber for the compression and acceleration of the flame, so as to further reduce the pressure rise time in the propulsion chamber.

With reference to FIG. 2, in which elements analogous to those of FIG. 1 are referenced with the same numbers, the apparatus has just two chambers: the final, propulsion, chamber 15, delimited downstream, on the same side as the cylinder 7, by the piston 6, and a first chamber 18, with multiple functions of precompression, generating the flame, compression and acceleration of the flame, with the fan 13 and the igniter plug 10, this first chamber 18 being tubular and communicating with the propulsion chamber 15 via a plurality of orifices 16 and one or more valves 17. For the remainder, the way in which the embodiment of FIG. 2 of the apparatus of the invention works is similar to the operation of the embodiment of FIG. 1.

In both cases, the precompression and final compression pressure level in the final last propulsion chamber 15 depends on the length and volume of the tubular chamber 14, 18. The tube may be coiled on itself to reduce the space occupied. It is also possible to envisage a modular design of the apparatus, as in the embodiment of FIG. 3.

The apparatus of FIG. 3 has three modules. A first, body, module 20 essentially comprises a cylinder 21, with its piston 22 and, at the rear behind the cylinder, the final, propulsion, chamber 23, the body being extended at the front by the buffer-guide 24.

Fixed under the body module 20 is a second, handle, module 25 with four compartments arranged roughly in a square: the compartment 26, containing the first, flame-generating, chamber 27, with its motor-fan unit 28, and the tubular chamber 29 for the compression and acceleration of the flame, bent downstream (30) for lateral connection to the final, propulsion, chamber 23 runs along the body 20; a second compartment 36, roughly orthogonal to the compartment 26 under the front of the body 20, in which a gas cartridge 31 can be housed, with its valve 32 for connection to the first chamber 27 for the filling of combustible gas runs under the first chamber 27; the actual handle 33, with the trigger 39, forming the second and third compartments 34, 35 roughly at right angles to one another, connects to the lower end of the compartment 36 of the cartridge and to the middle of the compartment 26 of the tubular chamber 29. Finally, the third module 37 in which a fastener (nail) loader can be aligned runs under the tip guide 24 and along the compartment 36 of the module 25.

Communication between the two chambers 29, 23 can here also be achieved via valve-controlled orifices 38. However, it may be noted at this point that it is possible to envisage dispensing with a valve to simplify the apparatus, depending on the desired operation and efficiency of the apparatus.

The way in which the apparatus of FIG. 3 works is obviously perfectly similar to the operation of the other two embodiments already described.

The modular design of the apparatus allows the sensitive components, such as the motor-fan unit 28, not to be subjected to the knocks and vibrations generated in the body module 20 of the cylinder 21 and the final propulsion chamber 23. Because of the reduced size of the first, flame-generating, chamber 27, it is possible to use just a small motor-fan unit 28 which will be of reasonable cost and will consume little energy, increasing the benefit of the apparatus from the battery power supply capacity point of view.

The modular design of the apparatus of FIG. 3 naturally also makes it possible to reduce its bulk and in particular its length. It will have been noted in this respect that there is no cylinder head behind the last, propulsion, chamber 23, which cylinder head element would, otherwise, bear the igniter plug and the means of powering it. Here, and although this has not been depicted, it is mounted in the handle module 25. Along the same line of thinking, the centre of gravity of the apparatus is lowered which, from a handling point of view, is an advantage. In short, the apparatus of FIG. 3 is very similar to an pneumatic apparatus.

A modular apparatus designed on the principle of three chambers of the type of those in the embodiment of FIG. 1 has just been described. Such a modular design is also entirely conceivable for the principle of the embodiment of FIG. 2 with two chambers.

1. Gas-operated apparatus comprising:
a first chamber for the precompression of a combustible gas and generation of a flame,
a second, propulsion, chamber, and
placing elements, the two chambers in communication to allow the flame to pass, wherein there is
an intermediate third chamber for the compression and acceleration of the flame, connecting the first and second chambers.

2. (canceled)

3. Apparatus according to claim 1, in which the chamber for compression and acceleration of the flame is a tubular chamber of a cross section roughly equal to that of the flame.

4. Apparatus according to claim 1, in which there is an accelerating fan in the first, flame-generating, chamber.

5. Apparatus according to claim 1, which is a sealing apparatus, the propulsion chamber of which is delimited by a piston for driving a fastener and intended to be propelled under the action of the exploding of the mixture in this propulsion chamber.

6. Apparatus according to claim 1, in which the said communication elements comprise valve elements.

7. Apparatus according to claim 1, in which the said communication elements comprise a number of orifices.

8. Apparatus according to claim 5, in which there is a body comprising a cylinder in which the piston is slidably mounted, a housing for accommodating a fasteners loader and a handling handle in which the chamber for the compression and acceleration of the flame is formed.

9. Apparatus according to claim 8, in which the flame-generating chamber is formed in the handle.

10. Apparatus according to claim 8, in which the propulsion chamber is formed at the rear of the body, behind the cylinder.

11. Apparatus according to claim 8, which comprises a body module, a loader housing module and a handle module.
